(19) United States
(12) Patent Application Publication
(10) Pub. No.: US 2012/0091168 A1
(43) Pub. Date: Apr. 19, 2012

(54) FLUID MATERIAL DISPENSER

(75) Inventor: Laurent Decottignies, Cergy (FR)

(73) Assignee: Airlessystems, Charleval (FR)

(21) Appl. No.: 13/378,882

(22) PCT Filed: Jun. 15, 2010
(86) PCT No.: PCT/FR2010/051183

§ 371 Date: Dec. 16, 2011

(30) Foreign Application Priority Data
Jun. 18, 2009 (FR) 0954090

(51) Int. Cl. B67D 7/06; B65D 37/00

(52) U.S. Cl. 222/205; 222/108; 222/207

(57) ABSTRACT

A fluid dispenser having a fluid reservoir (1) provided with an opening (13), a dispenser member (2) provided with a fluid outlet (24), a fastener ring (3) for fastening the dispenser member (2) on the opening (13) of the reservoir (1), and a dispenser head (4) mounted on the outlet (24) of the dispenser member (2). The head includes a dispenser orifice (43) and a pressing surface (44) to actuate the dispenser member (2). The head (4) also includes a fluid-collection dish (45) in which the fluid from the dispenser orifice (43) is collected before being taken by the user, and a peripheral skirt (46) secured to the ring (3) and/or to the reservoir (1). The skirt (46) is connected to the dish (45), to the pressing surface (44), and to the orifice (43) via a deformable flexible zone (47). The deformable zone (47) surrounds the dish (45), the pressing surface (44), and the dispenser orifice (43).

The present invention relates to a fluid dispenser comprising: a fluid reservoir provided with an opening; a dispenser member, such as a pump or a valve, provided with a fluid outlet; a fastener ring for fastening the dispenser member on the opening of the reservoir; and a dispenser head mounted on the outlet of the dispenser member, the head including a dispenser orifice and a pressing surface on which a user may press by means of a finger so as to actuate the dispenser member and thus dispense fluid through the dispenser orifice. The head further includes a fluid-collection dish in which the fluid from the dispenser orifice is collected before being taken by the user. An advantageous field of application of the present invention is the field of cosmetics, in particular in the form of cream, gel, and more generally high-viscosity fluids.

A conventional general configuration for this kind of fluid dispenser is in the form of a pot, with the dispenser head presenting the appearance of a lid that comes to close the pot formed by the reservoir, the dispenser member not being visible, and the fastener ring being suitable for interposing between the dispenser head and the reservoir. There already exist numerous dispensers having such a general configuration. A frequent drawback of this type of dispenser resides in the fact that the dispenser head is mounted axially on the outlet of the dispenser member, with the dispenser orifice situated on the axis of the dispenser member. Thus, in order to actuate the dispenser head, it is necessary to press on the dispenser head outside the axis of the dispenser member, since the dispenser orifice is situated at that location. As a result, the pressing force is completely off-center, thereby causing the dispenser head to lean or tilt. This is not very attractive, but in addition, it is necessary to press harder on the dispenser head in order to actuate it, given that said dispenser head tends to deform the outlet of the dispenser member. Thus, all of the pressing force is not used to actuate the dispenser member, but is used rather to deform the outlet and a portion of the dispenser head.

In order to overcome that drawback, a prior-art solution is to press on the dispenser head on either side of the dispenser orifice so as to balance the pressing force on the head. That solution is entirely suitable, but it forces the user to press on the head at two different locations, which firstly is not convenient, and which secondly does not satisfy all of the appearance criteria. Another drawback resulting from pressing on the dispenser head in off-centered manner resides in the fact that a fraction of the dispensed fluid may spread over the edge of the dispenser head and pass thereunder, such that it is no longer accessible. The fluid then deteriorates and dries out under the dispenser head, which is not acceptable from a hygienic point of view, and which also harms the quality image of the dispenser. This may occur as a result of the user collecting the dispensed fluid from the collection dish with a wiping or scraping movement of the fingers. Consequently, a fraction of the fluid may be pushed over the edge of the dispenser head and may accidentally pass under the dispenser head or into an inaccessible location.

An object of the present invention is to overcome the above-mentioned drawbacks of prior-art pot-type dispensers by defining a dispenser head that is properly actuated even when pressed in off-centered manner, and for which any risk of loss of fluid into inaccessible locations is eliminated.

To achieve the various objects, the present invention proposes that the dispenser head further includes a peripheral skirt that is secured to the ring and/or to the reservoir, the skirt being connected to the dish, to the pressing surface, and to the orifice via a deformable flexible zone. The peripheral skirt makes it possible to form a junction with the remainder of the dispenser, advantageously a leaktight junction, which eliminates any risk of loss of fluid into inaccessible locations. The appearance and the advantages of a conventional pot having a lid that is screw-fastened or clipped on a reservoir are thus reproduced. In addition, the deformable flexible zone makes it possible not only to connect the skirt to the remainder of the head, but especially makes it possible to balance the pressing force when said force is exerted in off-centered manner on the dispenser head. Advantageously, the dispenser head is made as a single piece by injection molding plastics material(s). Preferably, the dispenser head is made as a single piece by bi-injecting or overmolding two different plastics materials.

According to an advantageous characteristic of the invention, the deformable zone surrounds the dish, the pressing surface, and the dispenser orifice. As a result, even by pressing in off-centered manner on the dispenser head, the deformable zone enables the pressing force to be distributed over the periphery of the head, which reduces the tendency of the head to lean or to tilt. In a practical embodiment, the deformable zone is substantially annular and plane. While pressing on the pressing surface, the outer periphery of the deformable zone connected to the skirt remains stationary, whereas the inner periphery of the deformable zone connected to the dish and to the pressing surface moves. In a variant, the deformable zone is formed by the skirt in the form of a bellows. In this configuration, deformation is purely axial.

In a practical embodiment, the pressing surface, the dish, and the skirt are made of a plastics material that is substantially hard, while the deformable zone, and possibly the dispenser orifice, are made of a plastics material that is substantially flexible. The dispenser orifice may thus be made in the form of a self-sealing slot that is closed in the rest state, and that opens under the effect of the pressure of the fluid.

In a particularly advantageous aspect of the present invention, the reservoir presents an axis of symmetry X, the dispenser member presents an actuation axis Y, and the pressing surface presents a pressing axis Z, the actuation axis Y being parallel to, but offset from, the axis of symmetry X and the pressing axis Z. Advantageously, the pressing axis Z is parallel to, but offset from, the axis of symmetry X and the actuation axis Y. Preferably, the three axes X, Y, and Z lie in a plane of symmetry of the dispenser. It should be observed, firstly, that the offset configuration of the various axes may be used on any fluid dispenser, which need not necessarily have a dispenser head including a peripheral skirt secured to the ring and/or to the reservoir, and need not have the skirt connected to the remainder of the head via a deformable flexible zone. However, such particular dispositions of the various axes turn out to be particularly advantageous in the context of the present invention, given that the offsets between the axes make it possible to attenuate or to eliminate the problems associated with pressing with an off-center force. By offsetting the actuation axis from the axis of symmetry of the reservoir, it is possible to press along the actuation axis without creating tilting, while the center of the dispenser head coincides with the axis of symmetry of the reservoir. It is even possible to offset the pressing axis so that the pressing force is no longer centered on the actuation axis, with some or all of the off-centering of the pressing force being compensated by the deformable flexible zone.

The spirit of the invention resides in providing the dispenser head with a deformable flexible zone that distributes the pressing force over the dispenser head, even for off-centered application, the flexible zone also serving as a leaktight junction between the head and the stationary remainder of the dispenser, so as to avoid any loss of fluid or any infiltration of fluid into inaccessible locations of the dispenser. The flexible zone enables the various axes of the dispenser to be offset, given that it reduces or compensates for the harmful effects of an off-center pressing force.

The invention is described more fully below with reference to the accompanying drawings, which show an embodiment of the invention by way of non-limiting example.

### IN THE FIGURES

FIG. 1 is a perspective view of a fluid dispenser in an embodiment of the present invention, in the rest state;

FIG. 2 is a view similar to the view in FIG. 1, in the actuated state;

FIG. 3 is a vertical section view through the FIG. 1 dispenser; and

FIG. 4 is a vertical section view perpendicular to the view in FIG. 3 of the FIG. 1 dispenser.

The fluid dispenser shown in the figures presents an overall outward appearance that is similar or comparable to the outer appearance of a pot, such as those found in numerous fields, such as the field of cosmetics. Thus, the fluid dispenser of the present invention comprises four essential component elements, namely: a reservoir 1; a dispenser member 2; a fastener ring 3; and a dispenser head 4. Advantageously, the various elements may be made by injection-molding plastics material. Optionally, the reservoir 1 may be made of glass, of metal, or of composite material. Given that the reservoir 1 is relatively short and that the dispenser head is flat and presents a diameter that is substantially comparable to the diameter of the reservoir, the dispenser has the general appearance of a pot, with the dispenser head visually acting as a lid. However, in the present invention, the “pot” houses a dispenser member 2 for dispensing the fluid from the reservoir, and a fastener ring for holding the dispenser member on the reservoir.

The fluid reservoir 1 includes a bottom wall 11 and a circularly-cylindrical side wall. The diameter of the bottom wall 11 is large relative to the height of the wall 12, thereby giving the reservoir 1 the shape of a short pot. The top end of the side wall 12 defines an opening 13 that puts the outside of the reservoir into communication with the inside 10. Advantageously, the opening 13 is provided with appropriate fastener profiles making it possible to co-operate with the fastener ring 3, as described below. In this embodiment, the reservoir 1 presents a circularly-cylindrical configuration, but other geometrical configurations could be used without going beyond the ambit of the invention. The reservoir in the figures presents an axis of revolution X.

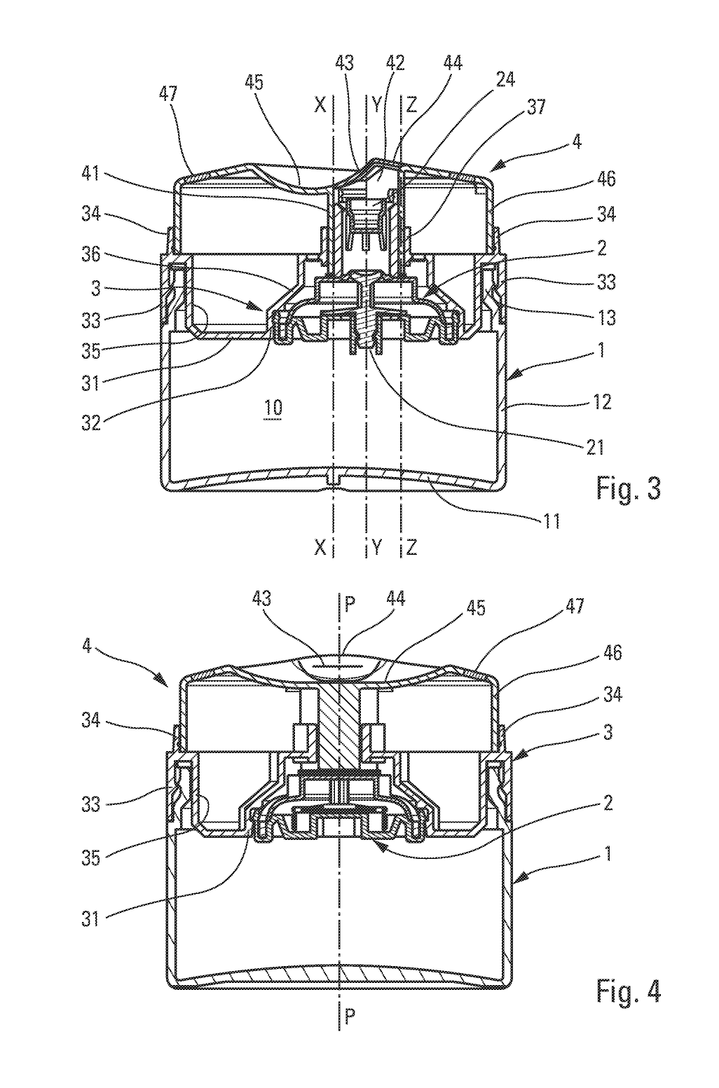

The dispenser member 2 that is shown in FIGS. 3 and 4, is a pump, but a valve could also be used in the context of the present invention. In conventional manner, the dispenser member 2 includes an inlet 21 and an outlet 24. The fluid from the reservoir 1 penetrates into the dispenser member via the inlet 21, and leaves the dispenser member via the outlet 24. The internal structural elements of the dispenser member and the operation thereof are those of a conventional pump or valve, and thus it is not necessary to describe them.

The function of the fastener ring 3 is to mount the dispenser member 2 in stationary and leaktight manner on or in the opening 13 of the reservoir 1. In the particular embodiment used to illustrate the present invention, the fastener ring 3 includes reception means 32 in the form of a snap-fastener housing in which the dispenser member 2 is received. The fastener ring 3 also includes a protective dome 36 that surrounds the dispenser member 2 in part. The dome 36 is terminated by a guide sleeve 37 that enables the dispenser member 2 to be guided axially. The fastener ring also defines a radial plate 31 that presents an off-centered configuration. In other words, the reception means 32, the dome 36, and the sleeve 37 are not arranged centrally on the plate 31, but, on the contrary, they are offset to one side, specifically the right-hand side, when looking at FIG. 3. The plate 31 is practically non-existent on the right-hand side of the dispenser member 2. In addition, the plate 31 extends from its outer periphery, so as to form a substantially cylindrical section 35 that comes into contact, advantageously leaktight contact, with the inside wall of the opening 13. The section 35 extends over the outside of the opening 13 by a fastener belt 33 that fastens the ring 3 on the opening 13. The fastener ring 3 also forms an annular flange 34 that projects upwards from the fastener belt 33. The flange 34 internally forms a snap-fastener groove having a function that is explained below. The particular embodiment of the above-described fastener ring should not be considered as unique: on the contrary, it is quite possible to imagine other shapes for a fastener ring that makes it possible to fasten a dispenser member, such as a pump or a valve, in leaktight manner on an opening or neck of a reservoir.

The dispenser head 4 is mounted on the outlet 24 of the dispenser member 2, and, to this end, defines an outlet chamber 42 downstream from the outlet 24. The chamber 42 communicates with the outside through a dispenser orifice 43 that may advantageously be made in the form of a self-sealing slot that is closed in leaktight manner at rest, and that opens under the effect of the pressure of the fluid so as to define an outlet passage. Advantageously, the self-sealing slot may be made out of a flexible plastics material. In order to fasten the dispenser head 4 on the dispenser member 2, the head 4 includes an interfitting bushing 41 that comes into engagement around the outlet 24 of the dispenser member 2. In the embodiment in the figures, the guide sleeve 37 surrounds the interfitting bushing 41. The dispenser head 4 also includes a pressing surface 44 on which the user can press by means of a finger so as to actuate the dispenser member 2. The pressing surface 44 is situated above the dispenser orifice 43 in slightly offset manner, as can be seen in the various figures. It can be said that the pressing surface 44 overlies the dispenser orifice 43 that is formed on the slope of a collection dish 45 for collecting the fluid that is dispensed through the dispenser orifice 43. It should be observed that the bottom of the dish is situated below the dispenser orifice 43 so that the fluid may flow or fall by gravity into the bottom of the dish 45. It should also be observed that the pressing surface 44, the dispenser orifice 43, and the bottom of the dish 45 are in alignment, as can be seen in FIG. 4. The dispenser head 4 also defines a peripheral skirt 46, in this embodiment of generally circularly-cylindrical shape, that is secured to the fastener ring 3, and more particularly to the flange 34. More precisely, the free bottom end of the skirt 46 is snap-fastened in the groove formed by the flange 34, so that the skirt 46 is secured in stationary manner on the ring 3. In a variant that is not shown, it is possible to imagine that the skirt 46 is fastened directly on a portion of the reservoir 1, or even on another element that is secured to the reservoir and/or to the fastener ring. The essential point is that the skirt is stationary relative to the reservoir and/or the ring.

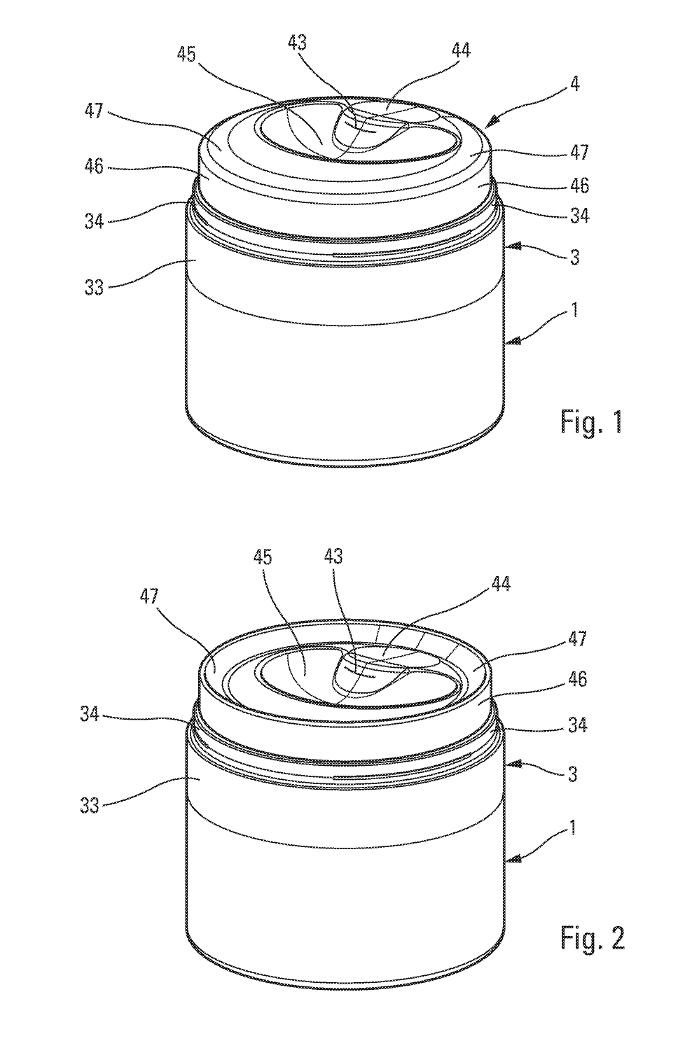

In the invention, the peripheral skirt 46 is connected to the remainder of the head, namely the collection dish 45, the pressing surface 44, and the dispenser orifice 43, via a deformable flexible zone 47. The deformable zone makes it possible to move the dish 45, the pressing surface 44, and the orifice 42 axially, while leaving the peripheral skirt 46 completely stationary. The flexible zone thus performs a hinge function between the skirt 46 and the remainder of the head 4. The deformable zone 47 may be formed by, or incorporated into, the peripheral skirt 46, e.g. in the form of a bellows. In a preferred variant that is shown in the figures, the deformable zone is in the form of an annular and substantially plane ring that connects the cylindrical skirt 46 to the remainder of the head. The outer peripheral edge of the deformable zone 47 connected to the skirt 46 remains stationary, while the inner periphery of the flexible zone 47 connected to the remainder of the head moves together with the dish 45, the pressing surface 44, and the orifice 43. At rest, and as shown in FIGS. 1, 3, and 4, the flexible zone 47 may be oriented inwards and slightly upwards. When the pressing surface 44 is pressed down fully, the deformable zone 47 adopts a configuration that slopes inwards and downwards, as can be seen in FIG. 2.

By means of the deformable flexible zone 47, there is no risk of the fluid being able to spread or infiltrate under the dispenser head, given that the skirt 46 is in engagement, advantageously leaktight engagement, with the fastener ring 3 at the flange 34. In addition, the deformable flexible zone guarantees better distribution of the pressing force exerted on the surface 44.

With reference once again to FIG. 3, it should be observed that the reservoir 1 presents an axis of symmetry and/or of revolution X, the dispenser member 2 presents an actuation axis Y, and the pressing surface 44 presents a pressing axis Z. In this embodiment, the three axes X, Y, and Z are distinct, but it is also possible to envisage making the axes Y and Z coincide. With reference to FIG. 4, it can be seen that the three axes X, Y, and Z lie in a single plane of symmetry P that is common to the dispenser as a whole. Even in the configuration in which the pressing axis Z is parallel, but offset, relative to the actuation axis Y, a pressing force exerted on the surface 44 (that is thus off-center relative to the actuation axis Y) does not cause the dispenser head to tilt, as a result of the presence of the deformable flexible zone 47 that acts to dispense the force over the periphery of the head. It should be observed that this particular disposition of the axes X, Y, and Z may be used in any fluid dispenser that is not necessarily provided with a deformable flexible zone, nor with a stationary peripheral skirt. In other words, separate protection could be sought for this characteristic.

The invention thus provides a dispenser in the form of a pot having a dispenser head that moves substantially axially, even when the pressing force is not exerted directly on the actuation axis of the dispenser member. In addition, the head is completely hygienic.

1. A fluid dispenser comprising:
a fluid reservoir (1) provided with an opening (13);
a dispenser member (2), such as a pump or a valve, provided with a fluid outlet (24);
a fastener ring (3) for fastening the dispenser member (2) on the opening (13) of the reservoir (1); and
a dispenser head (4) mounted on the outlet (24) of the dispenser member (2), the head including a dispenser orifice (43) and a pressing surface (44) on which a user may press by means of a finger so as to actuate the dispenser member (2) and thus dispense fluid through the dispenser orifice (43), the head (4) further including a fluid-collection dish (45) in which the fluid from the dispenser orifice (43) is collected before being taken by the user, the dispenser head (4) further including a peripheral skirt (46) that is secured to the ring (3) and/or to the reservoir (1), the skirt (46) being connected to the dish (45), to the pressing surface (44), and to the orifice (43) via a deformable flexible zone (47);
the deformable zone (47) surrounds the dish (45), the pressing surface (44), and the dispenser orifice (43).

2. A dispenser according to claim 1, wherein the dispenser head (4) is made as a single piece by injection molding plastics material(s).

3. A dispenser according to claim 1, wherein the dispenser head (4) is made as a single piece by bi-injecting or overmolding two different plastics materials.

4. A dispenser according to claim 1, wherein the deformable zone (47) is substantially annular and plane.

5. A dispenser according to claim 1, wherein the deformable zone is formed by the skirt in the form of a bellows.

6. A dispenser according to claim 1, wherein the pressing surface (44), the dish (45), and the skirt (46) are made of a plastics material that is substantially hard, while the deformable zone (47), and possibly the dispenser orifice (43), are made of a plastics material that is substantially flexible.

7. A dispenser according to claim 1, wherein the reservoir (1) presents an axis of symmetry X, the dispenser member (2) presents an actuation axis Y, and the pressing surface (44) presents a pressing axis Z, the actuation axis Y being parallel to, but offset from, the axis of symmetry X and the pressing axis Z.

8. A dispenser according to claim 7, wherein the pressing axis Z is parallel to, but offset from, the axis of symmetry X and the actuation axis Y.

9. A dispenser according to claim 7, wherein the three axes X, Y, and Z lie in a plane of symmetry (P) of the dispenser.
